(19) United States
(12) Patent Application Publication
(10) Pub. No.: US 2013/0170892 A1
(43) Pub. Date: Jul. 4, 2013

(54) Magnetic-Mechanical Connection Assembly and Writing Instrument Comprising Same

(71) Applicants: David Martin, Glynde Nr Lewes (GB); Leighton Davies-Smith, Founex (CH)

(72) Inventors: David Martin, Glynde Nr Lewes (GB); Leighton Davies-Smith, Founex (CH)

(73) Assignee: PARKER PEN PRODUCTS, East Sussex (GB)

(21) Appl. No.: 13/340,603

(22) Filed: Dec. 29, 2011

(51) Int. Cl. B43K 15/00; B43K 23/12

(52) U.S. Cl. 401/244; 401/251

(57) ABSTRACT

A writing instrument includes a nose section that is connected to a barrel housing portion that contains an ink reservoir for holding ink for delivery to a writing nib. A cap may be releasably secured to the barrel housing portion with a first magnetic-mechanical connection assembly to cover the nib to protect the nib from damage and to prevent ink evaporation. Similarly, the nose section may be releasably secured to the barrel housing portion with a second magnetic-mechanical connection assembly for accessing a replaceable ink cartridge that includes the ink reservoir.

### BACKGROUND

1. Field of the Invention

The invention generally relates to a writing instrument with a magnetic-mechanical connection assembly and more specifically to a writing instrument having a first magnetic-mechanical connection assembly releasably securing a cap to a barrel housing portion and a second magnetic-mechanical connection assembly releasably securing a barrel nose portion to the barrel housing portion.

2. Related Technology

Conventional writing instruments typically have a cap or cover of some sort that protects the writing nib and helps to prevent ink from evaporating from the nib when the writing instrument is not being used. Often the cap is a separate component that is releasably secured to a barrel of the writing instrument by an interference fit. Similarly, many conventional writing instruments have a replaceable cartridge that holds an ink reservoir. This replaceable cartridge is often housed in the barrel of the writing instrument. A nose section that holds the writing nib may be releasably secured to the barrel. The replaceable cartridge is typically accessed by removing the nose section from the barrel.

Generally, known writing instruments use one of two different connection mechanisms to releasably secure the cap to the barrel or to releasably secure the nose section to the barrel.

First, some known writing instruments use a threaded connection where the cap is screwed onto the barrel, or where the nose section is screwed onto the barrel. This type of threaded connection, while being secure, can be somewhat cumbersome for a consumer to use. Initially, the consumer must align the cap with the barrel (or the nose section with the barrel) and then the cap (or nose section) must be rotated through several revolutions to a secured position. The reverse operation is needed to remove the cap (or nose section). This threaded connection is therefore somewhat time consuming and inefficient to use, especially when the cap needs to be secured and removed from the barrel repeatedly in a short period of time. Additionally, the threaded connection can easily become damaged if the threads are improperly aligned prior to and/or during rotation.

A second type of connection is an interference connection that uses offset ridges, usually one on the outside of the barrel and one on the inside of the cap (or on the outside of the nose section and on the inside of the barrel). A consumer aligns the cap and the barrel (or the nose section and the barrel) and pushes the cap (or nose section) until one ridge slides over the other ridge to provide a secured position between the respective components. This type of connection is often called a “snap-fit” connection. While this type of connection is quicker to use, it is also more susceptible to inadvertent dislodgement as it is inherently weaker than the threaded connection. Additionally, this type of connection is prone to weakening (due to material loss from repeated frictional engagement) or warping over time.

### SUMMARY

An instrument comprises a nose section having a hollow channel and a first opening at one end of the hollow channel. A barrel housing portion has an interior, the nose section being at least partially disposed within the interior of the barrel housing portion. The nose section is releasably connected to the barrel housing portion opposite the first opening. A cap is releasably attached to the barrel housing portion to enclose the opening. A first magnetic-mechanical connection assembly between the cap and the barrel housing portion provides magnetic and mechanical force to secure the cap to the barrel housing portion. A second magnetic-mechanical connection assembly between the nose section and the barrel housing portion provides magnetic and mechanical force to secure the nose section to the barrel housing portion.

In another embodiment, a writing instrument comprises a nose section having an opening at one end. A writing nib extends through the opening. A barrel housing portion is releasably connected to the nose section opposite of the writing nib, the barrel housing portion having an ink reservoir for holding ink to be delivered to the writing nib. A cap is releasably connected to the barrel housing portion, the cap protecting the nib from damage. A first magnetic-mechanical connection assembly provides connection force for releasably connecting the cap to the barrel housing portion. A second magnetic-mechanical connection assembly provides connection force for releasably connecting the barrel housing portion to the nose section. The first magnetic-mechanical connection assembly includes at least one barrel housing magnet disposed on the barrel housing portion, at least one cap magnet disposed on the cap, at least one outer locking channel formed in an outer surface of the barrel housing portion, and at least one cap bayonet pin formed on an inner surface of the cap, the cap bayonet pin being sized and shaped to fit within the outer locking channel to mechanically secure the cap to the barrel housing portion such that the at least one barrel housing magnet and the at least one cap magnet are aligned to provide an attractive force therebetween. The second magnetic-mechanical connection assembly includes at least one nose magnet disposed on an outer surface of the nose section, at least one nose bayonet pin disposed on an outer surface of the nose section, and at least one inner locking channel disposed on an inner surface of the barrel housing portion, the nose bayonet pin being sized and shaped to fit within the inner locking channel to mechanically secure the nose section to the barrel housing portion, such that the at least one nose magnet and the at least one barrel housing magnet are aligned to provide an attractive force therebetween.

### BRIEF DESCRIPTION OF THE DRAWINGS

Further features and advantages of the invention can be gathered from the claims, the following description, and the attached diagrammatic drawings, wherein:

FIG. 1 is a plan view of a first embodiment of a writing instrument having a first magnetic-mechanical connection assembly and a second magnetic-mechanical connection assembly;

FIG. 2 is a partially exploded plan view of the writing instrument of FIG. 1;

FIG. 3 is a close-up perspective exploded view of the first magnetic-mechanical connection assembly and the second magnetic-mechanical connection assembly of FIGS. 1 and 2;

FIG. 4 is a schematic plan view of the first magnetic-mechanical connection assembly and the second magnetic-mechanical connection assembly of FIG. 3 when assembled and the components are rotated into a locked position;

FIG. 5 is a close-up perspective exploded view of an alternate embodiment of the second magnetic-mechanical connection assembly;

FIG. 6 is a schematic plan view of the alternate embodiment of the second magnetic-mechanical connection assembly of FIG. 5 when assembled and the nose section is rotated into a locked position;

FIG. 7 is an exploded perspective view of an alternate embodiment of a first magnetic-mechanical connection assembly;

FIG. 8 is a plan view of a ring magnet that may be used in either the first magnetic-mechanical connection assembly or the second magnetic-mechanical connection assembly; and

FIGS. 9 and 10 are perspective views of two ring magnets of FIG. 8 in various orientations with respect to one another generally illustrating the repelling and attractive forces generated during rotation.

### DETAILED DESCRIPTION

The disclosed writing instrument advantageously includes a magnetic-mechanical connection assembly requiring an opening force that is greater than the magnetic force alone that is generated between magnets in the magnetic-mechanical connection assembly because a mechanical interaction must also be overcome. The writing instrument relies on magnetic field attraction for a motive force to pull or twist one component into a secured position with respect to another component. The magnetic field attraction also provides continuing motive force to maintain the one component in the secured position. This magnetic field attraction must be overcome by a consumer to release the two components from one another. Thus, the writing instrument provides a consumer with a closure system that includes a quick-release connection having a tactile sensation that indicates a secured position. The quick-release connection allows a replacement or refill cartridge within the writing instrument to be easily replaced, or for a cap to be quickly secured to, or released from, a barrel housing portion.

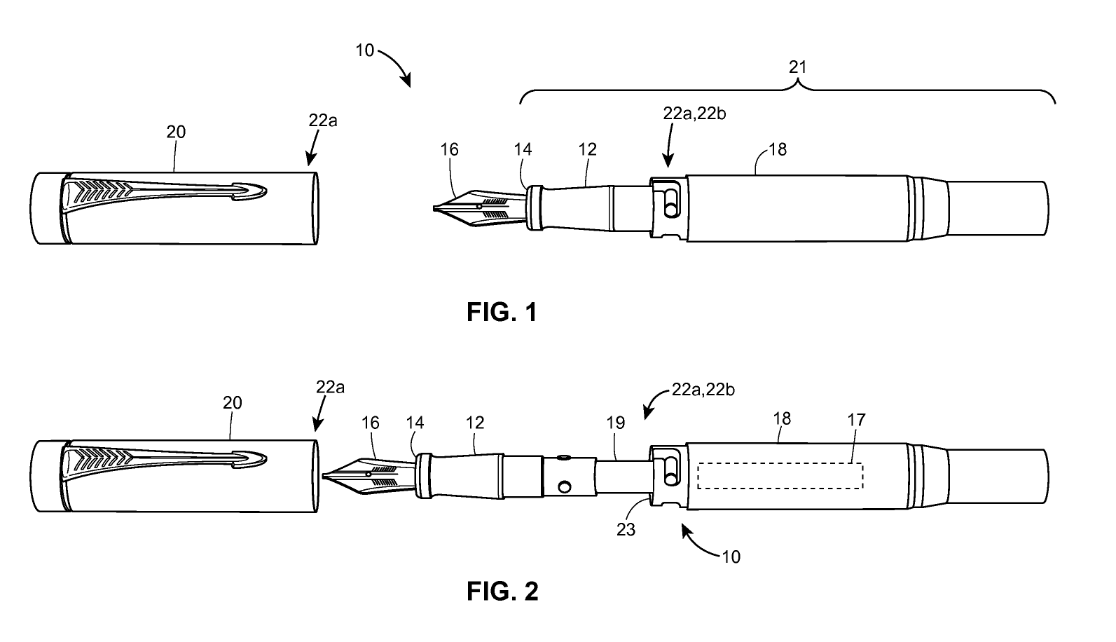

As illustrated in FIGS. 1 and 2, a fountain pen 10 is exemplified in the drawings, however, other writing instruments including, but not limited to markers, highlighters, ball pens, felt tip pens, and other fluid application devices including, but not limited to, correction fluid applicators and paint applicators could also be made in accordance with the teachings of the disclosure by selection of appropriate components. Similarly, other types of tools such as utility blades, screw drivers, punches, flashlights, etc., may be constructed in accordance with the teachings of the disclosure by substituting a tool for the illustrated writing nib.

The fountain pen 10 comprises a hollow nose section 12 having a first nose opening 14 at one end thereof through which a writing nib 16 extends. The nose section 12 is connected to a barrel housing portion 18 having an interior 17, which is sized to receive an ink reservoir 19 for delivery of an ink composition to the writing nib 16. The ink reservoir and the writing nib 16 are in fluid communication with one another. Together, the nose section 12 and the barrel housing portion 18 form a barrel 21 of the writing instrument 10. In one embodiment, the ink reservoir 19 takes the form of a replaceable cartridge. A cap 20 may be releasably connected to the barrel housing portion 18 proximate a first barrel opening 23 in the barrel housing portion 18 to cover the nib 16 when the nib 16 is not being used, so as to prevent ink from evaporating from the nib 16 and/or to prevent the nib 16 from becoming damaged. The cap 20 and barrel housing portion 18 include a first magnetic-mechanical connection assembly 22a that releasably secures the cap 20 to the barrel housing portion 18, and which facilitates and provides easy access to the writing nib 16. Similarly, the nose section 12 and barrel housing portion 18 include a second magnetic-mechanical connection assembly 22b that releasably secures the nose section 12 to the barrel housing portion 18, and which facilitates and provides easy access to the replaceable ink cartridge.

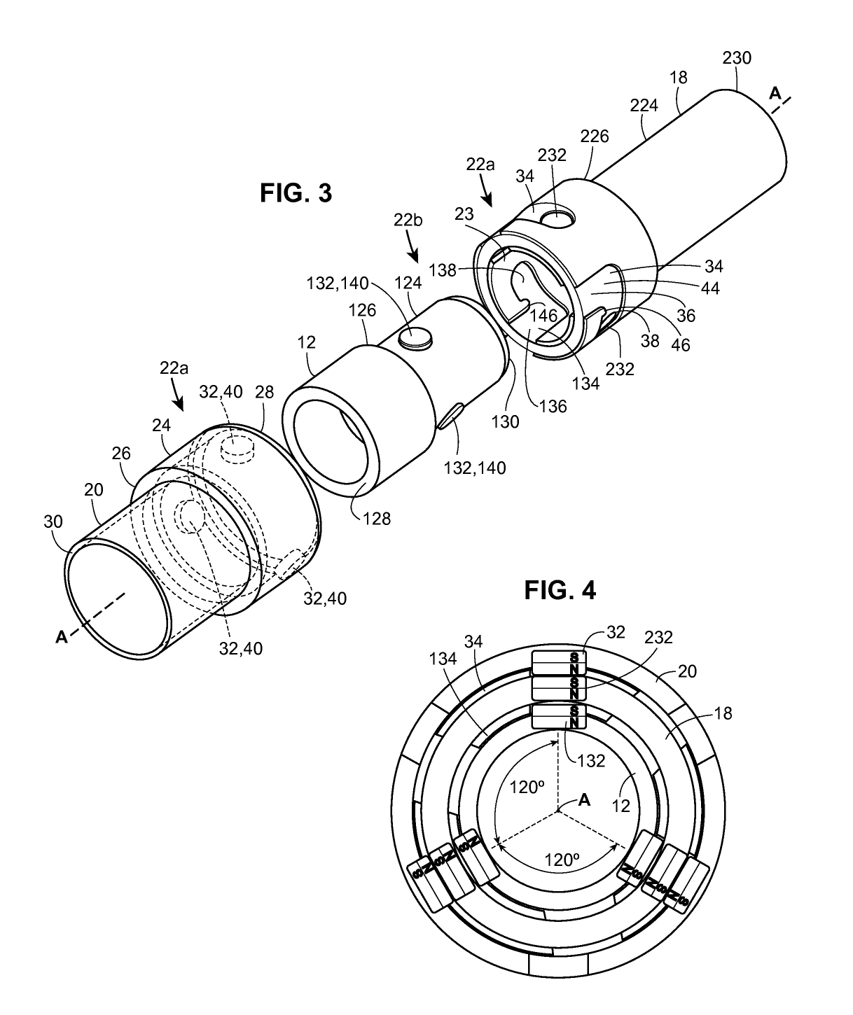

Turning now to FIG. 3, the first magnetic-mechanical connection assembly 22a and the second magnetic-mechanical connection assembly 22b are illustrated in further detail. FIG. 3 illustrates the cap 20, the nose section 12, and the barrel housing portion 18 being substantially aligned but separated from one another prior to connection. The cap 20 may include a cap connection portion 24 having one or more steps 26 or portions having an increased diameter relative to a second end 30, with a first open cap end 28 of the cap connection portion 24 being large enough to fit over at least a portion of the barrel housing portion 18. The second end 30 of the cap connection portion 24 may fit within a body of the cap 20.

The nose section 12 may include a nose connection portion 124 having one or more steps 126 or portions having an increased diameter relative to a second end 130, with a first open nose end 128 of the nose connection portion 124 being small enough to fit within a portion of the cap 20. The second end 130 of the nose connection portion 124 may fit within a body of the barrel housing portion 18.

The barrel housing portion 18 may include a barrel housing connection portion 224 having one or more steps 226 or portions having an increased diameter relative to a second end 230, with a first open barrel housing end 228 of the barrel housing connection portion 224 being large enough to fit over at least a portion of the nose section 12. The second end 230 of the barrel housing connection portion 224 may fit within a body of the barrel housing portion 18.

In other embodiments, the connection portions 24, 124, 224 may be integral with a body of the cap 20, a body of the nose section 12, and body of the barrel housing portion 18, respectively, to form a single, unitary cap, nose section, or barrel housing portion, respectively, each of which include the magnets, bayonet pins, and channels disposed in the connection portions 24, 124, 224, which are further described below.

The cap 20 may include one or more cap magnets 32 disposed around a periphery of the first end 28 of the connection portion 24. The cap magnets 32 may be disposed on an inner cap surface or the cap magnets 32 may be embedded within a wall of the connection portion 24. In the embodiment of FIG. 3, each cap magnet 32 is integrally formed with a cap bayonet pin 40 that extends inwardly from an inner surface of the cap 20. In other embodiments, the cap magnets 32 and the cap bayonet pins may be formed and located separately of one another.

One or more outer cams or outer locking channels 34 may be formed in an outer surface of the barrel housing connection portion 224. The one or more outer locking channels 34 may include a first outer portion 36 that is substantially parallel to a longitudinal axis A of the barrel housing connection portion 224 and a second outer portion 38 that is substantially perpendicular to the first outer portion 36. The first outer portion 36 and the second outer portion 38 may form a substantially L-shaped outer locking channel, but of course other suitable shapes may be used as well. The one or more outer locking channels 34 may extend partially through a thickness of the barrel housing connection portion 224, as illustrated in FIG. 3. In other embodiments, the one or more outer locking channels 34 may extend completely through the barrel housing connection portion 224.

In yet other embodiments, the cap magnets 32 and cap bayonet pins 40 and the outer locking channels 34 may be reversed. For example, the magnets 32 and the bayonet pins 40 may be formed on the outer surface of the barrel housing connection portion 224 and the locking channels 34 may be formed on an inner surface of the cap 20. As discussed above, the cap connection portion 24 may include one or more cap bayonet pins 40 disposed circumferentially about an inner surface of the cap connection portion 24. The cap bayonet pins 40 may have a generally cylindrical shape, extending from an inner surface of the cap connection portion 24, as illustrated in FIG. 3. In other embodiments, the cap bayonet pins 40 may have other shapes, such as rectangular, square, oval, polygon, etc. Regardless, the cap bayonet pins 40, 140 are sized and shaped to fit into, and slide within, the outer locking channel 34 on the barrel housing connection portion 224. The barrel housing connection portion 224 may include a plurality of barrel housing magnets 232 disposed around a circumference of the barrel housing connection portion 224. The cap magnets 32 may be oriented complementary to the barrel housing magnets 232 so that opposite poles are directed towards one another.

The cap 20 is secured to the barrel housing portion 18 by aligning the cap bayonet pins 40 with the first outer portion 36 of the outer locking channels 34. As the cap 20 is pushed in a direction substantially parallel to the longitudinal axis A of the barrel housing connection portion 224, the cap bayonet pins 40 slide within the first outer portion 36 of the outer locking channel 34 until the cap bayonet pins 40 are located at a junction 44 of the first outer portion 36 and the second outer portion 38 of the outer locking channel 34. Once the cap bayonet pins 40 are aligned with the second outer portion 38, the magnetic attraction between the cap magnets 32 and the barrel housing magnets 232 produces a twisting force that causes the cap 20 to twist into a secured position in which the cap magnets 32 and the barrel housing magnets 232 are generally aligned with one another and the cap bayonet pins 40 are seated at one end of the second outer portion 38 of the outer locking channel 34. After the cap magnets 32 and the barrel housing magnets 232 are aligned, the cap 20 is mechanically secured to the barrel housing portion 18 with the cap bayonet pins 40 being disposed within the outer locking channel 34. An outer lip 46 may be positioned within the outer locking channel 34, proximate the junction 44 to prevent the cap bayonet pins 40 from being inadvertently slid out of the outer locking channels 34. A consumer receives a tactile indication that the cap 20 is secured on the barrel housing portion 18 from the twisting force generated by the interaction between the cap magnets 32 and the barrel housing magnets 232.

The first magnetic-mechanical connection assembly 22a comprises at least one cap magnet, at least one cap bayonet pin, at least one barrel housing magnet 232, and at least one outer locking channel 34. In other embodiments, the plurality of cap magnets 32 and/or the plurality of barrel housing magnets 232 may be replaced by a ring magnet, as illustrated and discussed below with respect to FIGS. 8-10.

The nose connection portion 124 may include one or more nose magnets 132 disposed about a periphery of the nose connection portion 124. In the embodiment of FIG. 3, the nose magnets 132 are formed integrally with the nose bayonet pins 140. In other embodiments, the nose magnets 132 and the nose bayonet pins 140 may be formed and located separately from one another. The nose magnets 132 may have a polarity that is oriented complementary to the polarity of the barrel housing magnets 232 so that the nose magnets 132 and the barrel housing magnets 232 are magnetically attracted to one another.

One or more inner cams or inner locking channels 134 may be formed in on inner surface of the barrel housing connection portion 224. The one or more inner locking channels 134 may include a first inner portion 136 that is substantially parallel to a longitudinal axis A of the barrel housing connection portion 224 and a second inner portion 138 that is substantially perpendicular to the first inner portion 136. The first inner portion 136 and the second inner portion 138 may form a substantially L-shaped inner locking channel, of course other suitable shapes may be used as well. The one or more inner locking channels 136 may extend partially through a thickness of the barrel housing connection portion 224, as illustrated in FIG. 3. In other embodiments, the one or more inner locking channels 134 may extend completely through the barrel housing connection portion 224.

As discussed above, the nose connection portion 124 may include one or more nose bayonet pins 140 disposed about a periphery of the nose connection portion 124. The nose bayonet pins 140 may have a generally cylindrical shape, extending from an inner surface of the outer surface of the nose connection portion 124, as illustrated in FIG. 3. In other embodiments, the nose bayonet pins 140 may have other shapes, such as rectangular, square, oval, polygon, etc. Regardless, the nose bayonet pins 140 are sized and shaped to fit into, and slide within, the inner locking channel 134 on the barrel housing connection portion 224. In yet other embodiments, the nose magnets 132 and nose bayonet pins 140 and the inner locking channels 134 may be reversed. For example, the magnets and the bayonet pins may be formed on the inner surface of the barrel housing connection portion 224 and the locking channels may be formed on an outer surface of the nose connection portion 124.

The second magnetic-mechanical connection assembly 22b comprises at least one nose magnet, at least one nose bayonet pin, at least one barrel housing magnet 232, and at least one inner locking channel 134. In other embodiments, the plurality of nose magnets 132 and/or the plurality of barrel housing magnets 232 may be replaced by a ring magnet, as illustrated and discussed below with respect to FIGS. 8-10.

Similarly to the cap 20, the nose section 12 is secured to the barrel housing portion 18 by aligning the nose bayonet pins 140 with the first inner portion 136 of the inner locking channels 134. As the nose 12 is pushed in a direction substantially parallel to the longitudinal axis A of the barrel housing connection portion 224, the nose bayonet pins 140 slide within the first inner portion 136 of the inner locking channel 134 until the nose bayonet pins 140 are located at a junction 144 of the first inner portion 136 and the second inner portion 138 of the inner locking channel 134. Once the nose bayonet pins 140 are aligned with the second inner portion 138, magnetic attraction between the nose magnets 132 and the barrel housing magnets 232 produces a twisting force that causes the nose section 12 to twist into a secured position in which the nose magnets 132 and the barrel housing magnets 232 are generally aligned with one another and the nose bayonet pins 140 are seated at one end of the second inner portion 138 of the inner locking channel 134. After the nose magnets 132 and the barrel housing magnets 232 are aligned, the nose section 12 is mechanically secured to the barrel housing portion 18 with the nose bayonet pins 140 being disposed within the inner locking channel 134. An inner lip 146 may be positioned within the inner locking channel 134, proximate the junction 144 to prevent the nose bayonet pins 140 from being inadvertently slid out of the inner locking channels 134. A consumer receives a tactile indication that the nose section 12 is secured on the barrel housing portion 18 from the twisting force generated by the interaction between the nose magnets 132 and the barrel housing magnets 232.

The first and second magnetic-mechanical connection assemblies 22a, 22b cooperate with one another when the cap 20 and nose section 12 are attached to the barrel housing portion 18 because the first and second magnetic-mechanical connection assemblies share a common component, namely the barrel housing magnets 232. This cooperation is illustrated further below.

FIG. 4 schematically illustrates the relative positioning between the cap magnets 32, the nose magnets 132, and the barrel housing magnets 232 when the cap 20 and the nose section 12 are secured to the barrel housing 18. Once the cap bayonet pins 40 are aligned with the second outer portion 38 of the outer locking channel 34 on the barrel housing connection portion 224, magnetic attraction between the cap magnets 32 and the barrel housing magnets 232 produces a twisting force that rotates the cap 20 relative to the barrel housing portion 18 and into a secured position. Likewise, once the nose bayonet pins 140 are aligned with the second inner portion 138 of the inner locking channel 134 of the barrel housing connection portion 224, magnetic attraction between the nose magnets 132 and the barrel housing magnets 232 produces a twisting force that rotates the nose section 12 relative to the barrel housing 18 and into a locked position. Once the cap magnets 32, the nose magnets 132, and the barrel housing magnets 232 are aligned adjacent to one another, as illustrated in FIG. 4, the cap bayonet pins 40 and outer locking channels 34 mechanically secure the cap 20 to the barrel housing portion 18, and the nose bayonet pins 140 and the inner locking channels 134 mechanically secure the nose section 12 to the barrel housing portion 18 as described above. In the embodiment of FIGS. 3 and 4, the barrel housing magnets 232 are part of both the first magnetic-mechanical connection assembly 22a and the second magnetic-mechanical connection assembly 22b. In other words, the first and second magnetic-mechanical connection assemblies 22a, 22b share at least one component and interact at least magnetically with one another.

As illustrated in FIG. 4, the cap magnets 32, the nose magnets 132, and the barrel housing magnets 232 may take the form of disc magnets having a north pole and a south pole. The cap magnets 32 may have their magnetic fields oriented in a complimentary direction to magnetic fields of the barrel housing magnets 232 so that north and south poles of adjacent magnets face one another to produce a magnetic attraction. For example, the cap magnets 32, the barrel housing magnets 232, and the nose magnets 132 may all have a south pole oriented radially outward and a north pole oriented radially inward. In other embodiments, the cap magnets 32, the barrel housing magnets 232, and the nose magnets 132 may have a north pole oriented radially outward and a south pole oriented radially inward, essentially opposite of the orientations illustrated in FIG. 4. In yet other embodiments, the cap magnets 32, the nose magnets 132, and the barrel housing magnets 232 may have varying orientations as long as adjacent magnets (when aligned upon securing the respective components to one another) have opposite poles facing one another. In the embodiment of FIG. 4, the cap magnets 32 are spaced equidistantly around an inner surface of the cap 20. Each of the cap magnets 32 are separated by approximately 120°. The nose magnets 132 and the barrel housing magnets 232 have a similar spacing and angular orientation. In other embodiments, more or less than three cap magnets 32, nose magnets 132, and/or barrel housing magnets 232 may be used and the relative angular orientation of the cap magnets 32, the nose magnets 132 and barrel housing magnets 232 may be varied as desired. In yet other embodiments, the cap magnets 32, the nose magnets 132, and the barrel housing magnets 232 need not be equally spaced or have equal angular orientations.

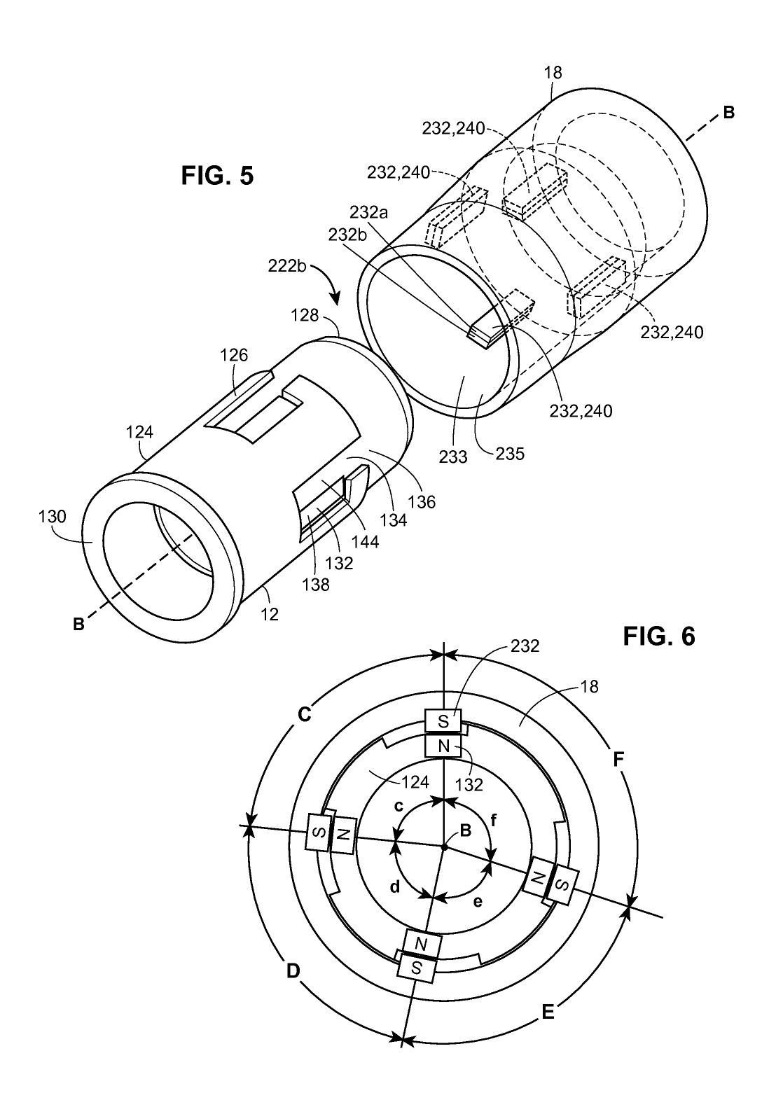

Turning now to FIG. 5, an alternate embodiment of the second magnetic-mechanical connection assembly 222b is illustrated in further detail. FIG. 5 illustrates a nose connection portion 124 of the nose section 12 and one end of the barrel housing portion 18. The nose connection portion 124 may include one or more steps 126 of increased diameter relative to a second end 128, with the first end 128 of the nose connection portion 124 being small enough to fit within a portion of the barrel housing portion 18. A second end 130 of the nose connection portion 124 is large enough fit over part of the nose section 12 so that the nose connection portion 124 is essentially an extension of the nose section 12. In other embodiments, the nose connection portion 124 may be integral with the nose section 12 to form a single, unitary nose section or the second end 130 of the nose connection portion 124 may be small enough to fit within part of the nose section 12.

The barrel housing portion 18 may include one or more barrel housing magnets 232 disposed within a hollow bore 233 of the barrel housing portion 18. The barrel housing magnets 232 may be disposed on an inner surface 235 of the hollow bore 233, or the barrel housing magnets 232 may be embedded within a wall of the barrel housing portion 18. The barrel housing magnets 232 may take the form of a bi-polar bar magnet, as illustrated in FIG. 5, having a north pole 232a and a south pole 232b. In the embodiment of FIG. 5, the barrel housing magnets 232 also function as barrel housing bayonet pins 240 that extend inwardly from the inner surface 235 of the hollow bore 233. In other embodiments, the barrel housing magnets 232 and the barrel housing bayonet pins 240 may be formed and located separately from one another. One or more cams or locking channels 134 may be formed in an outer surface of the nose connection portion 124, proximate the first end 128. The locking channels 134 may include a first portion 136 that is substantially parallel to a longitudinal axis B of the nose connection portion 124 and a second portion 138 that is substantially perpendicular to the first portion 136. The first portion 136 and the second portion 138 may form a substantially L-shaped channel, of course other shapes may be used as well. The one or more locking channels 134 may extend completely through a thickness of the nose connection portion 124, or the one or more locking channels 134 may extend only partially through a thickness of the nose connection portion 124, as illustrated in FIG. 5. The one or more locking channels 134 are shaped and sized to receive one of the barrel housing bayonet pins 140 formed on the inner surface 235 of the barrel housing portion 18 to mechanically secure the nose connection portion 124, and thus the nose section 12, to the barrel housing portion 18.

The nose section 12 may include one or more nose magnets 132 disposed about a periphery of the nose section 12 and located proximate the second portion 138 of the locking channel 134. The nose magnets 132 may have a polarity that is oriented complimentary to the polarity of the barrel housing magnets 232 so that the nose magnets 132 and the barrel housing magnets 232 are magnetically attracted to one another. To releasably secure the nose connection portion 124 to the barrel housing portion 18, the first portion 136 of the locking channel 134 is aligned with a barrel housing magnet 232 (which in this embodiment also serves as a barrel housing bayonet pin 240). As the nose connection portion 124 is moved axially substantially parallel to the longitudinal axis B, the barrel housing bayonet pin 240 will travel along the first portion 136 of the locking channel 134. Once the barrel housing bayonet pin 240 reaches a junction 144, magnetic attraction between the barrel housing magnet 232 and the nose magnet 132 will generate a twisting force that will rotate either the nose connection portion 124 or the barrel housing portion 18 to bring the barrel housing magnets 232 and the nose magnets 132 into general alignment with one another such that the barrel housing magnets 232 are seated in the second portion 138 of the locking channel 134 to provide a mechanical lock between the nose section 12 and the barrel housing portion 18.

FIG. 6 schematically illustrates the relative positioning between the barrel housing magnets 232 and the nose magnets 132 as the barrel housing portion 18 is secured to the nose section 12. In the embodiment of FIG. 6, there are four barrel housing magnets 232 and four nose magnets 132. For ease of reference, the barrel housing magnets 232 and the nose magnets 132 are illustrated with only a single pole. However, both the barrel housing magnets 232 and the nose magnets 132 are bi-polar. In this embodiment, the nose magnets 132 may not be spaced equidistantly around the perimeter of the nose connection portion 124. Likewise, the barrel housing magnets 232 may not be spaced equidistantly around an inner perimeter of the barrel housing portion 18. For example, while distances C, D, and E may be substantially equal, distance F may be larger than distances C, D, and E. Likewise, angular orientations may not be equal between each of the nose magnets 132 and between each of the barrel housing magnets 232. For example, three angles c, d, and e may be substantially equal (e.g., approximately 85 degrees) while angle f may be larger than angles c, d, and e (e.g., approximately 105 degrees). This unequal spacing of the nose magnets 132 and the barrel housing magnets 232 provides a single radial locking position between the nose connection portion 124 and the barrel housing portion 18. In other words, there is only one radial position that will allow the nose section 12 to be secured to the barrel housing portion 18. This single radial position may be beneficial to align graphics or other features on the nose section 12 with graphics or other features on the barrel housing portion 18.

As illustrated in FIG. 5, the barrel housing magnets 232 and the nose magnets 132 may take the form of bar magnets having a north pole 232a and a south pole 232b. The barrel housing magnets 232 may have magnetic fields oriented in a complimentary direction to magnetic fields of the nose magnets 132. For example, the barrel housing magnets 232 may have a south pole 232b oriented radially inward and a north pole 232a oriented radially outward. Likewise, the nose magnets 132 may have the north pole oriented radially outward and the south pole oriented radially inward. In other embodiments, the barrel housing magnets 232 and the nose magnets 132 may have a north pole oriented radially inward and a south pole oriented radially outward, essentially opposite of the orientations illustrated in FIG. 6. In yet other embodiments, the barrel housing magnets 232 and the nose magnets 132 may have varying orientations as long as adjacent magnets have opposite orientations when the barrel housing portion 18 is in a secured position with the barrel housing magnets 232 seated in the second portion 138 of the locking channel 134.

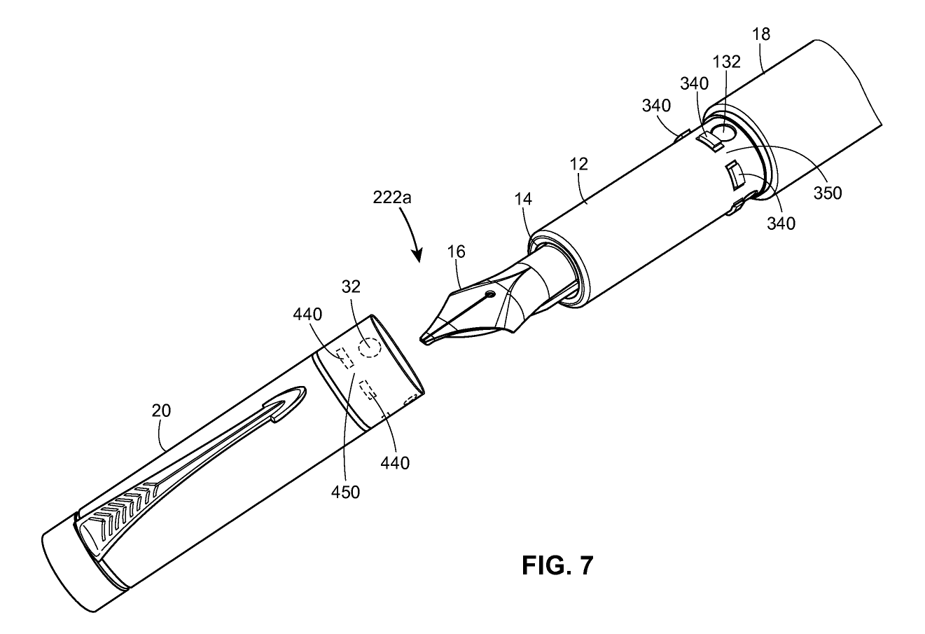

In another embodiment of the first magnetic-mechanical connection assembly 222a, illustrated in FIG. 7, the nose section 12 may include a plurality of nose projections or nose lugs 340 disposed about a periphery of the nose section 12. A nose space 350 is formed between each of the nose lugs 340 resulting in a plurality of nose spaces 350 being disposed about a periphery of the nose section 12. The nose section 12 may also include one or more nose magnets 132.

The cap 20 may include a plurality of cap lugs 440 disposed circumferentially about an inner surface of the cap 20. A cap space 450 may be disposed between each of the cap lugs 440 resulting in a plurality of cap spaces 450 being disposed circumferentially about an inner surface of the cap 20. The cap 20 may also include one or more cap magnets 32.

To secure the cap 20 to the nose section 12, the cap lugs 440 are generally aligned with the nose spaces 350. As the cap 20 moves along a longitudinal axis of the nose section 12, the cap lugs 440 will pass between the nose lugs 340 through the nose spaces 350. Once the cap lugs 440 are located beyond the nose lugs 340 such that the cap lugs 440 are located between the nose lugs 340 and the barrel housing portion 18, magnetic attraction between the nose magnets 132 and the cap magnets 32 generates a twisting force that rotates the cap 20 relative to the nose section 12 until the cap magnets 32 and the nose magnets 132 are substantially aligned with one another. Similarly, the nose lugs 340 and the cap lugs 440 will also be generally aligned with one another, which helps prevent the cap 20 from being inadvertently removed from the nose section 12.

The second magnetic-mechanical connection assembly is not visible in FIG. 7 because the nose section 12 is secured to the barrel housing portion 18 and the second magnetic-mechanical connection assembly is hidden from view. However, the second magnetic-mechanical connection assembly of FIG. 7 is consistent with the second magnetic-mechanical connection assemblies described above.

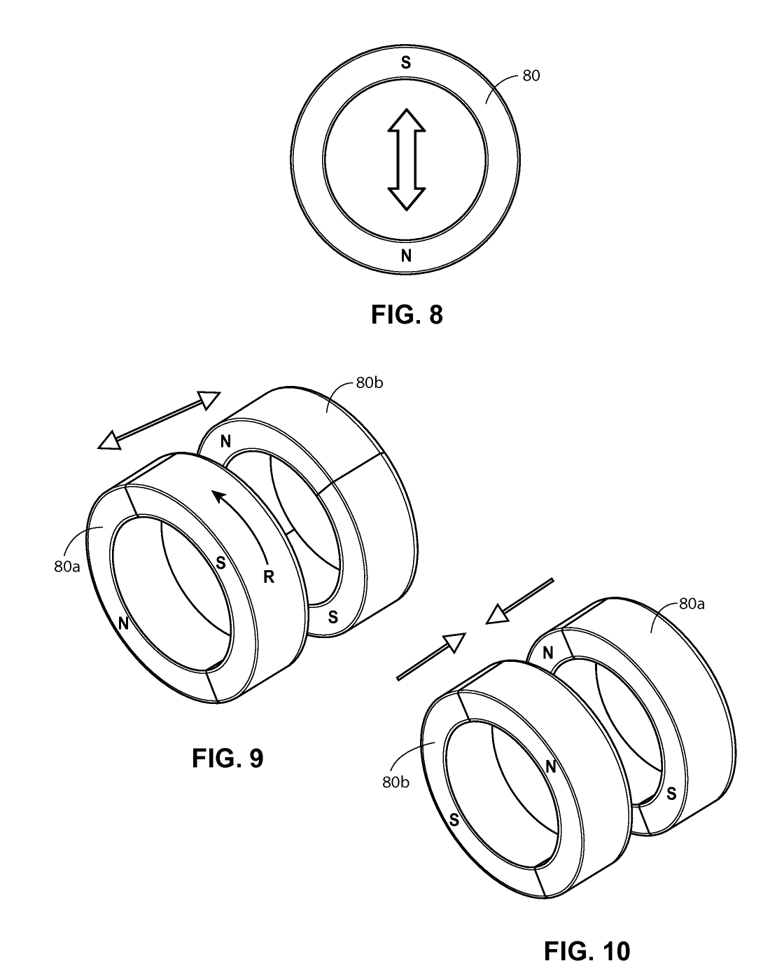

FIGS. 8-10 illustrate one embodiment of polarized ring magnets 80 that may be used for any of the cap magnets 32, the nose magnets 132, and the barrel housing magnets 232 of the previous embodiments. The polarized ring magnets 80 may be formed as a ring of magnetic material having a north pole opposite a south pole. When two ring magnets 80a, 80b are located adjacent one another, as when the nose section 12 is being attached to the barrel housing portion 18, or as when the cap 20 is being attached to the barrel housing portion 18, the first ring magnet 80a initially has the north and south poles offset with respect to the north and south poles of the second ring magnet 80b, as illustrated in FIG. 9. The orientation in FIG. 9 corresponds to a position of the nose section 12 in which the nose bayonet pins 140 are generally aligned with the first inner portion 136 of the inner locking channel 134, or a position of the cap 20 in which the cap bayonet pins 40 are generally aligned with the first outer portion 36 of the outer locking channel 34 (FIG. 3). A repulsive force is produced because there is more overlap between the north poles of the first and second ring magnets 80a, 80b (likewise for south poles of the two magnets) than there is overlap between respective north and south poles (which creates an attractive force). This repulsive force gives a consumer a non-visual (e.g., a tactile) indication that the cap 20 is properly aligned with the barrel housing portion 18 and/or that the nose section 12 is properly aligned with the barrel housing portion 18.

As the first ring magnet 80a is rotated in the direction of R (FIG. 9), the north pole of the first ring magnet 80a gradually becomes aligned with the south pole of the second ring magnet 80b, causing the repulsive force to gradually decrease, and eventually change to a net attractive force that results in twisting of the cap 20 relative to the barrel housing portion 18 and/or in twisting of the nose section 12 relative to the barrel housing portion 18. This net attractive force gives a consumer a non-visual (e.g., a tactile) indication that the cap 20 or nose section 12 is approaching a fully seated (i.e., a secured) position on or within the barrel housing portion 18. Moreover, this net attractive force maintains the cap 20 or the nose section 12 in the secured position, which reduces the possibility of the cap 20 or the nose section 12 becoming inadvertently dislodged.

Any suitable magnet may be used to provide the cap magnets 32, the nose magnets 132, and/or the barrel housing magnets 232. In one embodiment, the cap magnets 32, the nose magnets 132, and/or the barrel housing magnets 232 may comprise neodymium iron boron disc super magnets having a field strength of approximately 400 g. In other embodiments, various combinations of disc magnets may be arranged to produce an initial repulsive force followed by a twist-attraction, as described above.

In yet other embodiments, the cap magnets 32, the nose magnets 132, and/or the barrel housing magnets 232 may comprise diametrically polarized ring super magnets, which can produce either a repulsive or attractive force when a pair of such magnets are brought together depending on relative orientations of the respective north and south poles, as discussed above. Of course, other magnets can also be positioned to produce a repulsive force when the cap 20 is properly aligned with the barrel housing portion 18 and/or that the nose section 12 is properly aligned with the barrel housing portion 18, which transitions to a net attractive force that results in twisting of the cap 20 and/or of the nose section 12 relative to the barrel housing portion 18.

In yet other embodiments, the cap magnets 32, the nose magnets 132, or the barrel housing magnets 232 may comprise a magnetic plastic resin. For example, the plastic resin can be infused with magnetic material and then subjected to a magnetic field before the resin sets in order to orient particles of the magnetic material in the same direction, thereby imparting magnetic properties to the plastic resin.

In the disclosed embodiments, the magnetic attractions are used to provide a seating force and the attractive force between magnets is not solely relied upon as a connecting force between cap and barrel housing portion or between nose section and barrel housing portion but rather a mechanical interaction provides a significant portion of the connecting force so that the overall connecting force is greater than the magnetic force alone.

The disclosure is not limited to a fountain pen. The disclosure could be applied to virtually any writing instrument or tool, such as utility blades, flashlights, screw drivers, or other similar instruments. The features of the invention disclosed in the description, drawings and claims can be individually or in various combinations for the implementation of the different embodiments of the invention.

1. An instrument comprising:
a nose section having a hollow channel and a first opening at one end of the hollow channel;
a barrel housing portion having an interior, the nose section being at least partially disposed within the interior of the barrel housing portion, the nose section being releasably connected to the barrel housing portion opposite the first opening;
a cap releasably attached to the barrel housing portion to enclose the opening;
a first magnetic-mechanical connection assembly between the cap and the barrel housing portion that provides magnetic and mechanical force to secure the cap to the barrel housing portion; and
a second magnetic-mechanical connection assembly between the nose section and the barrel housing portion that provides magnetic and mechanical force to secure the nose section to the barrel housing portion.

2. The instrument of claim 1, wherein the first magnetic-mechanical connection assembly and the second magnetic-mechanical connection assembly share at least one component.

3. The instrument of claim 2, wherein the shared component comprises at least one barrel housing magnet.

4. The instrument of claim 1 wherein the second magnetic-mechanical connection assembly includes a plurality of nose magnets disposed about a periphery of the nose section.

5. The instrument of claim 4 wherein the second magnetic-mechanical connection assembly includes a plurality of nose bayonet pins disposed about a periphery of the nose section.

6. The instrument of claim 5, wherein at least one nose magnet is integrally formed with at least one nose bayonet pin.

7. The instrument of claim 5 wherein the plurality of nose bayonet pins are spaced equidistantly from one another.

8. The instrument of claim 4 wherein the plurality of nose magnets are spaced equidistantly from one another.

9. The instrument of claim 8, wherein the plurality of nose magnets includes three nose magnets, each nose magnet being separated radially by approximately 120 degrees from the other nose magnets.

10. The instrument of claim 1 wherein the first magnetic-mechanical connection assembly includes a plurality of cap magnets disposed about an inner surface of the cap.

11. The instrument of claim 1 wherein the first magnetic-mechanical connection assembly includes a plurality of cap bayonet pins disposed about an inner surface of the cap.

12. The instrument of claim 1 wherein the second magnetic-mechanical connection assembly includes a plurality of inner locking channels disposed about an inner surface of the barrel housing portion.

13. The instrument of claim 12 wherein the first magnetic-mechanical connection assembly includes a plurality of outer locking channels disposed about an outer surface of the barrel housing portion.

14. The instrument of claim 12 wherein at least one inner locking channel includes a first inner portion that is substantially parallel to a longitudinal axis of the nose and a second inner portion that is substantially perpendicular to the first inner portion.

15. The instrument of claim 12 wherein the at least one inner locking channel includes a lip.

16. The instrument of claim 1 wherein one of the first magnetic-mechanical connection assembly and the second magnetic-mechanical connection assembly includes at least one ring magnet.

17. The instrument of claim 1 wherein the first magnetic-mechanical connection includes a plurality of cap lugs disposed about an inner surface of the cap and a plurality of nose lugs disposed about a periphery of the nose section.

18. The instrument of claim 17, wherein the plurality of cap lugs are separated from one another by a plurality of cap spaces and the plurality of nose lugs are separated from one another by a plurality of nose spaces, each of the cap lugs being sized and shaped to fit within one of the nose spaces.

19. The instrument of claim 17, further comprising a tool extending from the nose section, the tool being selected from the group consisting of, a utility blade, a screw driver, a punch, and a flashlight.

20. A writing instrument comprising:
a nose section having an opening at one end;
a writing nib extending through the opening;
a barrel housing portion releasably connected to the nose section opposite of the writing nib, the barrel housing portion having an ink reservoir for holding ink to be delivered to the writing nib;
a cap releasably connected to the barrel housing portion, the cap protecting the nib from damage; and
a first magnetic-mechanical connection assembly that provides connection force for releasably connecting the cap to the barrel housing portion; and
a second magnetic-mechanical connection assembly that provides connection force for releasably connecting the barrel housing portion to the nose section,
wherein the first magnetic-mechanical connection assembly includes at least one barrel housing magnet disposed on the barrel housing portion, at least one cap magnet disposed on the cap, at least one outer locking channel formed in an outer surface of the barrel housing portion, and at least one cap bayonet pin formed on an inner surface of the cap, the cap bayonet pin being sized and shaped to fit within the outer locking channel to mechanically secure the cap to the barrel housing portion such that the at least one barrel housing magnet and the at least one cap magnet are aligned to provide an attractive force therebetween, and
wherein the second magnetic-mechanical connection assembly includes at least one nose magnet disposed on an outer surface of the nose section, at least one nose bayonet pin disposed on an outer surface of the nose section, and at least one inner locking channel disposed on an inner surface of the barrel housing portion, the nose bayonet pin being sized and shaped to fit within the inner locking channel to mechanically secure the nose section to the barrel housing portion, such that the at least one nose magnet and the at least one barrel housing magnet are aligned to provide an attractive force therebetween.

21. The writing instrument of claim 20, wherein the cap magnet is a ring magnet.

22. The writing instrument of claim 20 wherein the nose magnet is a ring magnet.

23. The writing instrument of claim 20 wherein the barrel housing magnet is a ring magnet.

24. The writing instrument of claim 20 further comprising a lip within one or more of the outer locking channel and the inner locking channel.

25. The writing instrument of claim 20 wherein one of the at least one cap magnet, the at least one nose magnet, and the at least one barrel housing magnet comprises a magnetic plastic material.
